(19) United States
(12) Patent Application Publication
(10) Pub. No.: US 2025/0342690 A1
(43) Pub. Date: Nov. 6, 2025

(54) COLLABORATIVE INFERENCE BETWEEN CLOUD AND ONBOARD NEURAL NETWORKS FOR UAV DELIVERY APPLICATIONS

(71) Applicant: Wing Aviation LLC, Mountain View, CA (US)

(72) Inventor: Ali Shoeb, San Rafael, CA (US)

(21) Appl. No.: 18/656,241

(22) Filed: May 6, 2024

(51) Int. Cl. G06V 20/17; G06V 10/764; G06V 10/82

(52) U.S. Cl. CPC G06V 20/17; G06V 10/764; G06V 10/82

(57) ABSTRACT

A method of collaborative analysis of a ground area by UAV delivery service includes acquiring first and second aerial images of the ground area. The first and second aerial images include depictions of objects at the ground area. A query including an encoding of the first aerial image is transmitted to a cloud-based neural network trained to identify objects. A motion of the UAV is tracked between acquiring the first and second aerial images. A response is received from the cloud-based neural network identifying one or more of the objects depicted in the first aerial image. An onboard neural network disposed on board the UAV is used to identify the objects at the ground area. The onboard neural network receives the response, an indication of the motion tracked between the first and second aerial images, and the second aerial image as input when identifying the objects.

### TECHNICAL FIELD

This disclosure relates generally to collaborative inference between neural networks for unmanned aerial vehicle (UAV) applications.

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various different missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby providing package pick-ups and deliveries almost anywhere. To safely deliver packages in a variety of environments (particularly populated urban/suburban environments), the UAV should be capable of effectively identifying safe drop spots at a delivery destination while avoiding ground-based obstacles. The ability to obtain low latency and high-fidelity semantic analysis of the scene at a delivery destination can facilitate safe deliveries in a wide range of environments and conditions.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A illustrates operation of an unmanned aerial vehicle (UAV) delivery service that delivers packages into a neighborhood, in accordance with an embodiment of the disclosure.

FIG. 1B illustrates a package drop-off at a delivery destination, in accordance with an embodiment of the disclosure.

FIG. 2 is a functional block diagram illustrating a system for navigation of UAVs, in accordance with an embodiment of the disclosure.

FIG. 3 illustrates components of a UAV delivery system that facilitate collaborative analysis of a delivery destination, in accordance with an embodiment of the disclosure.

FIG. 4A includes a flow chart illustrating an edge-side process for collaborative analysis of a delivery destination, in accordance with an embodiment of the disclosure.

FIG. 4B includes a flow chart illustrating a cloud-side process for collaborative analysis of a delivery destination, in accordance with an embodiment of the disclosure.

FIG. 5A is a perspective view illustration of a UAV configured for use in a UAV delivery system, in accordance with an embodiment of the disclosure.

FIG. 5B is an underside plan view illustration of the UAV configured for use in the UAV delivery system, in accordance with an embodiment of the disclosure.

FIG. 6 is an example aerial image from a UAV during a cruise segment, in accordance with an embodiment of the disclosure.

### DETAILED DESCRIPTION

Embodiments of a system, apparatus, and method of operation for collaborative analysis of a delivery destination by an unmanned aerial vehicle (UAV) delivery service are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Extremely large foundation, multi-modal vision-language models are demonstrating increasingly impressive performance on scene understanding tasks. However, these models are very large and difficult to run on low-compute, power constrained platforms such as UAVs. The techniques described herein leverage collaborative analysis/inference of the scene at a delivery destination by combining both “edge” and “cloud” models to semantically analyze aerial images thereby improving obstacle avoidance, drop spot selection, and delivery descent route planning.

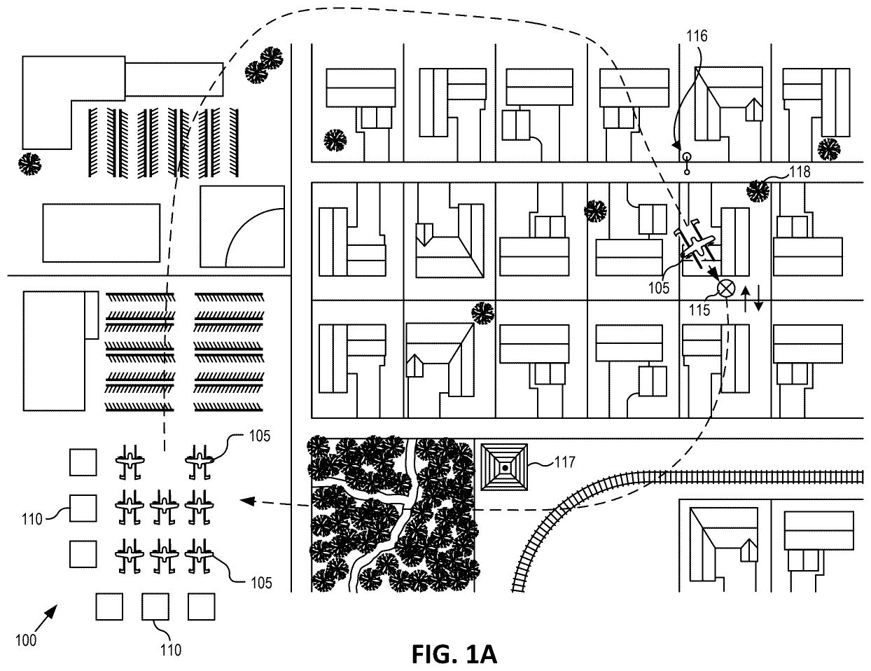

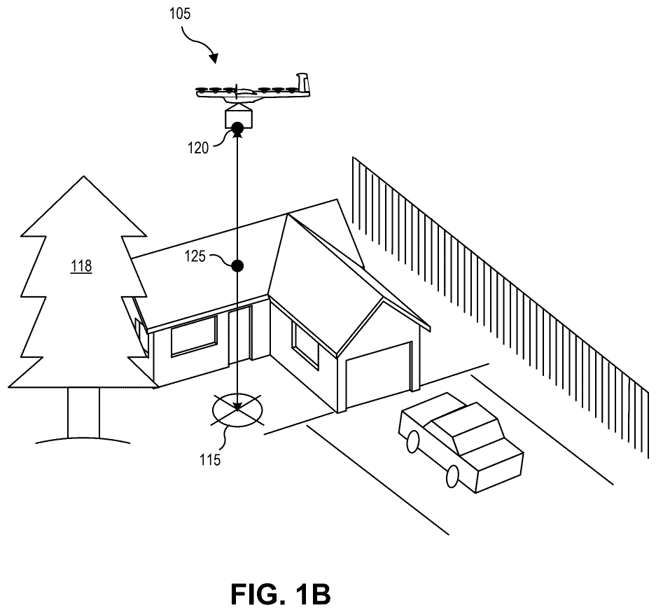

FIG. 1A illustrates operation of a UAV service supplier (USS), such as a UAV delivery service that delivers packages into a neighborhood by leveraging collaborative analysis, in accordance with an embodiment of the disclosure. UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood for waypoint package pickups (not illustrated). An example aerial delivery mission may include multiple mission phases such as takeoff from terminal area 100 with a package for delivery to a destination area (also referred to as a delivery zone or delivery destination), rising to a cruising altitude, and cruising to the customer destination.

Turning to FIG. 1B illustrating an example delivery destination, UAV 105 captures aerial images of the destination area to understand the scene and identify objects to avoid (ground-based obstacles) and a location for safe package drop-off. An initial aerial image may be captured at a first higher altitude 120 before descending to a drop-off altitude 125. The initial aerial image is semantically analyzed by an onboard neural network (edge model) disposed on board UAV 105 to acquire an initial understanding of the scene. The semantic analysis produces a semantic segmentation, which categorizes each pixel, group of pixels, or feature in the image into a class or object. In select situations, UAV 105 solicits a cloud-based neural network (cloud model) for collaborative semantic analysis of the scene in situations where UAV 105 has an insufficient level of confidence in its understanding/identification of the objects (e.g., obstacles such as streetlights 116, telephone poles, radio towers 117, cranes, trees 118 etc.) or lacks confidence in identification of a suitable drop spot 115. UAV 105 uses the collaborative analysis to produce a higher quality semantic segmentation of the aerial images it acquires, which in turn identify/classify the objects present at the delivery destination. The semantic segmentation is then used by other onboard algorithms/models to perform obstacle avoidance and select a suitable drop spot 115 for delivery of the package. With a sufficient confidence in its understanding of the scene, the obstacles present, and a suitable drop spot 115 selected, UAV 105 can safely descend to a hover altitude 125 for package drop-off before once again ascending to a cruise altitude for the return cruise back to terminal area 100.

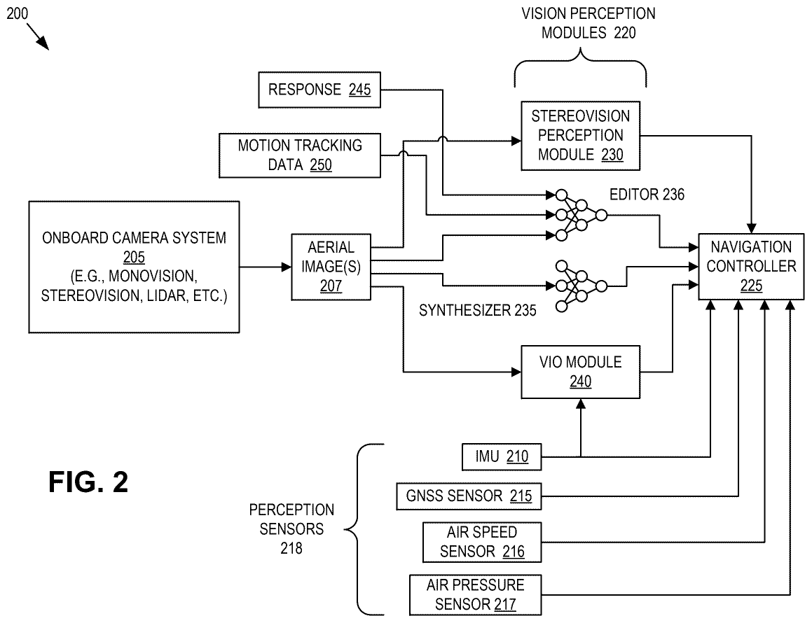

FIG. 2 is a functional block diagram illustrating a system 200 disposed on board UAVs 105 for vision-based navigation of UAVs 105, in accordance with an embodiment of the disclosure. The illustrated embodiment of system 200 includes an onboard camera system 205 for acquiring aerial images 207, an inertial measurement unit (IMU) 210, a global navigation satellite system (GNSS) sensor 215, an air speed sensor 216 (e.g., pitot tube), an air pressure sensor 217 (e.g., barometer), vision perception modules 220, and a navigation controller 225. Collectively, the sensors 210-217 are referred to as perception sensors 218. The illustrated embodiment of vision perception modules 220 includes a stereovision perception module 230, one or more semantic segmentation models including a synthesizer model 235 and an editor model 236, and a visual inertial odometry (VIO) module 240.

Onboard camera system 205 is disposed on UAVs 105 with a downward looking orientation to acquire aerial images 207. Aerial images 207 may be acquired at a regular video frame rate (e.g., 20 f/s, 30 f/s, etc.) and a subset of the images provided to the various vision perception modules 220 for analysis. Onboard camera system 205 may be implemented as a monovision camera system, a stereovision camera system, a laser imaging, detection, and ranging (LIDAR) camera system, an infrared sensor, a combination of these systems, or otherwise. As such, aerial images 207 may be monochromatic or color images, stereovision images, lidar images, infrared images, or include other modalities. While capturing aerial images 207, the camera intrinsics along with sensor readings from the onboard perception sensors 218 may be recorded and indexed to aerial images 207. For example, IMU 210 may include one or more of an accelerometer, a gyroscope, or a magnetometer to capture accelerations (linear or rotational), attitude, and heading readings. GNSS sensor 215 may be a global positioning system (GPS) sensor, or otherwise, and output longitude/latitude position, mean sea level (MSL) altitude, heading, speed over ground (SOG), etc. Air speed sensor 216 captures air speed of UAV 105 while underway, which may serve as a rough approximation for SOG when adjusted for weather conditions. Air pressure sensor 217 measures air pressure, which provides MSL altitude, which may be offset using elevation map data to estimate above ground level (AGL) altitude. Aerial images 207 and/or the outputs of perception sensors 218 are generically referred to as sensor data.

During flight missions, vision perception modules 220 are operated as part of the onboard machine vision system and may constantly receive aerial images 207 and identify objects (e.g., obstacles, driveways, sidewalks, roads, fences, buildings, etc.) represented in those aerial images. Stereovision perception module 230 analyzes parallax between stereovision aerial images acquired by onboard camera system 205 to estimate distance to pixels/features/objects in aerial images 207. These stereovision depth estimates may be referred to as a stereovision depth map. VIO module 240 estimates the three-dimensional (3D) pose (e.g., position/orientation) of onboard camera system 205 of UAV 105 using aerial images 207 and IMU 210. In other words, VIO module 240 provides ego-motion tracking relative to the surrounding environment of UAV 105. The semantic segmentation models produce semantic segmentations to inform object detection/identification and feature tracking by downstream algorithms such as navigation controller 225. Feature tracking includes the identification and tracking of features within aerial images 207. Features may include edges, corners, high contrast points, etc. of objects within aerial images 207. Recognized objects, which are identified/classified by the semantic segmentation models may be tracked and the identification labels (classifications) provided to other modules responsible for making real-time flight decisions. Vision perception modules 220 may also include other vision perception modules (not illustrated) such as a lidar analysis module or an optical flow analysis module to extract distance/depth information from aerial images 207. Collectively, vision perception modules 220 provide vision-based analysis and understanding of the surrounding environment, which may be used by navigation controller 225 to inform navigation decisions and perform localization, automated obstacle avoidance, route traversal, drop spot selection, etc. Of course, the output from the vision perception modules 220 may be combined with, or considered in connection with, other real-time sensor data from IMU 210, GNSS sensor 215, airspeed sensor 216, and air pressure sensor 217 by navigation controller 225 to make more fully informed navigation decisions.

The semantic segmentation models are neural networks that use machine learning (ML) based semantic segmentation to classify objects depicted in aerial images 207. In the illustrated embodiment, semantic analysis is performed via two distinct models—synthesizer model 235 and editor model 236. Synthesizer model 235 generates a first impression semantic segmentation of aerial images 207 based on the images themselves without more. In contrast, editor model 236 generates a revised or updated semantic segmentation based on a baseline semantic segmentation obtained from elsewhere, such as a cloud-based neural network. Editor model 236 is trained to take as input the baseline semantic segmentation embedded in response 245 along with motion tracking data 250 and updated aerial images 207. Editor model 236 may be viewed as editing or updated the baseline semantic segmentation received from the cloud using updated aerial images 207 and motion tracking data 250 that tracks the motion of UAV 105 between an initial aerial image 207 used by the cloud-based neural network to generate the baseline semantic segmentation and each subsequent aerial image 207 used to revise/edit the baseline semantic segmentation. Accordingly, the baseline semantic segmentation may be viewed as a sort of key frame segmentation that editor model 236 revises with updates and changes based upon new aerial images 207. Motion tracking data 250 enables editor 236 to correlate objects depicted in new aerial images 207 to objects previously identified/classified in the baseline semantic segmentation. Motion tracking data 205 itself may be generated using outputs from VIO module 240, stereovision perception module 230, and/or perception sensors 218.

Although FIG. 2 illustrates synthesizer model 235 and editor model 236 as distinct neural networks, it should be appreciated that synthesizing and editing may be different operating regimes of a single semantic segmentation model. For example, during synthesizing operation, the baseline semantic segmentation and motion tracking data 250 may be null dataset inputs. Alternatively, a single onboard neural network may operate recursively by receiving its own previous semantic segmentation generated based on a previous aerial image 207 to facilitate creation of an updated semantic segmentation. In other words, the baseline semantic segmentation may be created by a cloud-based neural network and received in response 245, or created locally on board UAV 105 based on a previous aerial image 207.

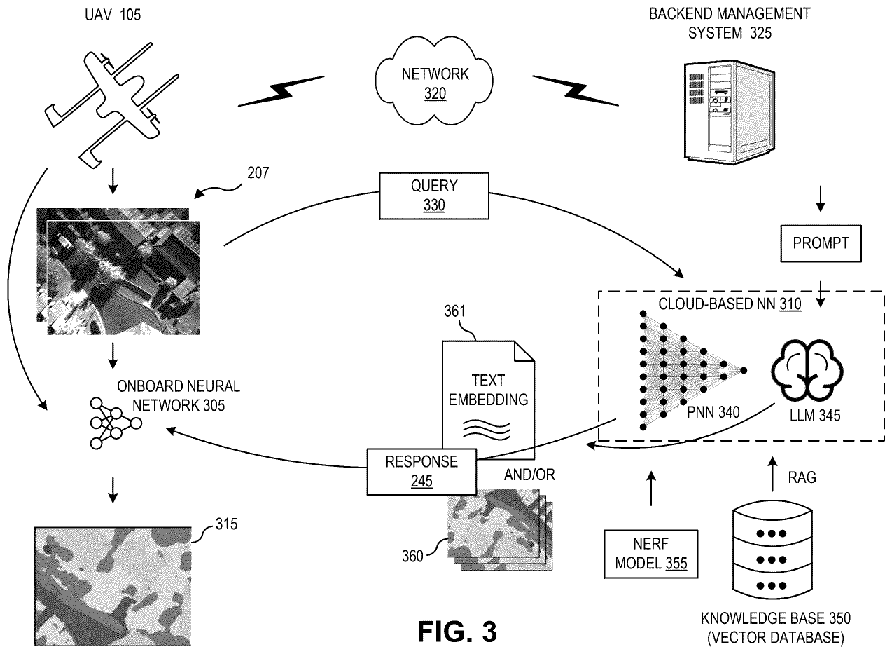

FIG. 3 illustrates components of the UAV delivery system that facilitate collaborative analysis using an onboard neural network 305 and a cloud-based neural network 310 to semantically analyze a delivery destination, in accordance with an embodiment of the disclosure. Onboard neural network 305 may be implemented with synthesizer model 235 and/or editor model 236 to perform semantic analysis of aerial images 207 to generate a semantic segmentation 315. As mentioned above, semantic segmentation 315 is provided to downstream algorithms, such as navigation controller 225, of UAV 105.

During operation, UAV 105 acquires aerial images 207 and sends one or more over network 320 to a backend management system 325 of the UAV delivery service. In one embodiment, network 320 includes a wireless gateway (e.g., cellular LTE, etc.) coupled with the Internet. Backend management system 325 is coupled with cloud-based neural network 310 to provide cloud-based semantic analysis of select aerial images 207 received from UAV 105. The select aerial images 207 may be encoded (e.g., image embedding, compressed image file, etc.) and incorporated within a query 330 conveyed to cloud-based neural network 310. Cloud-based neural network 310 enables UAVs 105 to collaborate with larger, more robust neural networks than their limited compute and power resources can support. In one embodiment, cloud-based neural network 310 is a single, proprietary neural network (PNN) 340 similar to onboard neural network 305, but significantly larger and capable of handling more parameters. In one embodiment, cloud-based neural network 310 is a large language model (LLM) 345 capable of performing a vector query based upon a textual prompt combined with an image embedding. In one embodiment, cloud-based neural network 310 is a multi-modal vision-language model capable of accepting both an image or image embedding along with a textual prompt. In various embodiments, backend management system 325 may host/access multiple types of cloud-based neural networks along with additional knowledge of the delivery destination stored in a knowledge database 350 and may even maintain a three-dimensional model (e.g., neural radiance field (NeRF) model 355) of the delivery destination. Knowledge database 350 may be implemented as a vector database that augments the knowledge of the PNN 340 and/or LLM 345 using a retrieval augmented generation (RAG) approach.

In an example where cloud-based neural network 310 is a PNN 340 that performs a robust semantic analysis of the aerial image encoded into query 330, response 245 may simply include a single semantic segmentation 360. Alternatively or additionally, PNN 340 may query NeRF model 355 to generate additional semantic segmentations 360 that are returned to UAV 105 in response 245. These additional semantic segmentations 360 may each correspond to a different altitude perspective that UAV 105 is expected to encounter as it descends towards its drop-off altitude 125 from its initial higher altitude 120.

In an example where cloud-based neural network 310 is a LLM 345, backend management system 325 may combine the embedded image received in query 330 with a textual prompt. An example prompt may include “I am a delivery drone carrying a package. I am hovering above the delivery destination imaged in the attached image. I want to deliver the package at this delivery destination without damaging me or getting the package wet. Are there obstacles in this aerial image that could damage me? Where is it safe for me to deposit the package?” Of course, other prompts may be used and/or tailored to specific environments, delivery destinations, or scenarios.

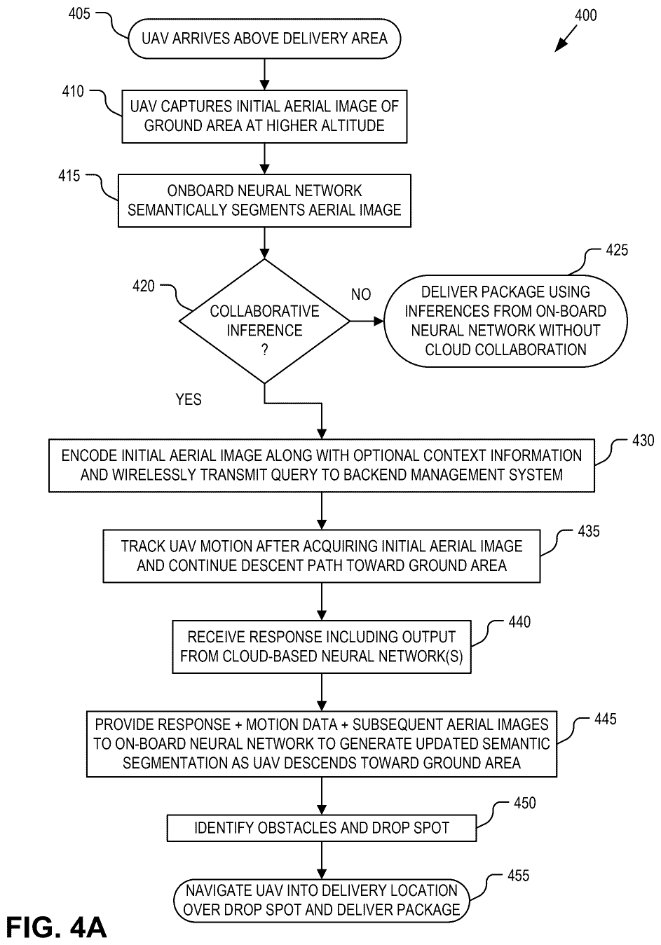

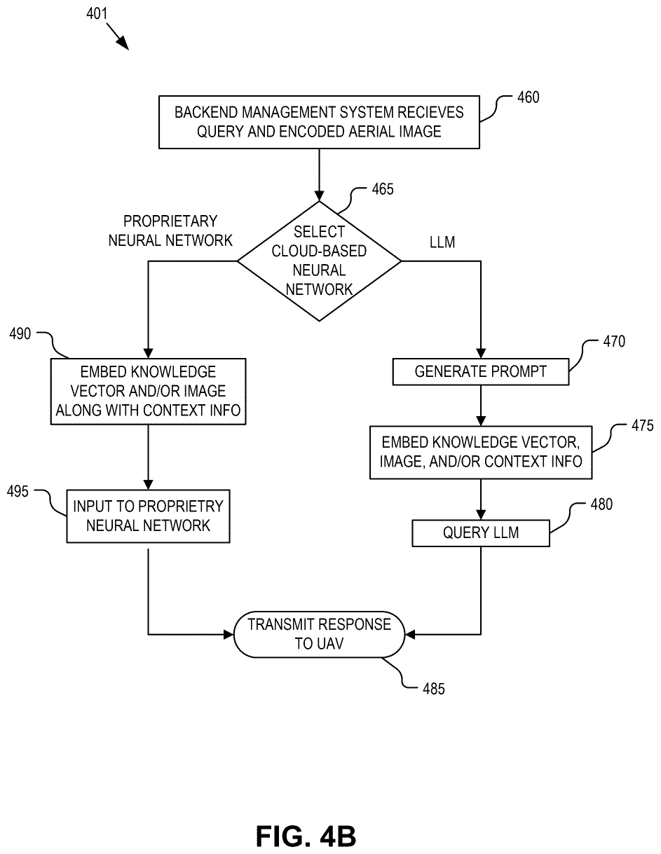

FIG. 4A includes a flow chart illustrating an edge-side process 400 for collaborative analysis of a delivery destination, in accordance with an embodiment of the disclosure. Process 400 is described with reference to FIGS. 1B and 3. The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel.

In a process block 405, UAV 105 arrives on scene over the delivery destination/area with a package (see FIG. 1B). UAV 105 captures an initial aerial image 207 of the ground area at the delivery destination from an initial higher altitude 120, such as 40 m (process block 410). The initial aerial image 207 includes depictions of objects at the delivery destination some of which may be obstacles to avoid while others may be suitable drop spots 115. It should be appreciated that the term “initial” is not intended to necessarily connote the very first image of the delivery destination, but rather a relative order that is earlier in time than subsequent aerial images.

The initial aerial image 207 is semantically analyzed and segmented by onboard neural network 305 to identify the various objects including potential obstacles and drop spots 115 (process block 415). The semantic analysis performed by onboard neural network 305 may also indicate an identification confidence level for classifying one or more objects (obstacles and/or drop spot). If the confidence level is high, then UAV 105 may determine that collaborative analysis of the delivery destination is not desired or necessary (decision block 420) and UAV 105 proceeds to descend to drop-off altitude 125 and drop off the package at drop spot 115 without collaborating with a cloud-based neural network 310 (process block 425). A determination that a confidence level is high may be based upon a number of factors. Such factors may include objects within a threshold distance of an identified drop spot 115 are all identified/classified above a minimum threshold level of confidence (e.g., 95% level of confidence), whether past deliveries have been made to the delivery destination, whether any object depicted within the aerial image falls below a minimum identification confidence level or otherwise. Other factors that may be considered include whether UAV 105 has adequate power budget to hover and wait for response 245 and whether the fee for delivering the package is sufficient to justify the financial expense associated with seeking collaborative inference. For example, the delivery fee for an inexpensive item may not justify the wireless data expense and the LLM query fee. In scenarios where the onboard neural network 305 isn't sufficiently confident of its semantic analysis of the delivery destination and the delivery fee or power budget can't accommodate a collaborative analysis, the delivery mission may be aborted.

If collaborative analysis/inference is deemed necessary, or otherwise desirable, then process 400 continues to a process block 430. In process block 430, UAV 105 encodes the initial aerial image 207 and includes it with query 330 wirelessly transmitted to backend management system 325 and cloud-based neural network 310. The encoding may be a compressed image file format, an image embedding, or otherwise. In one embodiment, UAV 105 also gathers context information describing one or more environmental factors present at the delivery destination. Example environmental factors include weather conditions (wind, rain, snow, overcast, etc.), lighting conditions (e.g., presence of glare, sunset, sunrise, ambient brightness, etc.), time and date, season, temperature, etc. These environmental factors may be relevant information for cloud-based neural network 310 to consider when analyzing the initial aerial image 207.

Upon capturing the initial aerial image 207, UAV 105 commences tracking its motion (process block 435). UAV 105 may remain at its initial higher altitude 120 and wait for response 245, in which case any potential drift is tracked. Alternatively, UAV 105 may commence its descent towards drop-off altitude 125 and track that descent motion. In a process block 440, response 245 including the output from cloud-based neural network 310 is received. The output may include a single semantic segmentation 360, a series of semantic segmentations 360 each representing a different semantic segmentation of the delivery destination at a different altitude, a text embedding 361 describing at least one obstacle to avoid or describing a drop spot 115 to deposit the packet, a combination of the above, or otherwise.

In a process block 445, a subsequent aerial image 207 is captured at a new location (e.g., lower altitude location, lateral drift location, etc.). The subsequent aerial image 207 along with the motion tracking data 250 and response 245 is input into onboard neural network 305, which uses the input data to semantically analyze/classify objects at the scene including any potential obstacles (process block 450). Downstream algorithms, such as navigation controller 225 reference the updated semantic segmentation to select a suitable drop spot 115, navigate to the selected drop spot 115, and navigate around any identified obstacles (process block 455).

FIG. 4B includes a flow chart illustrating a cloud-side process 401 for collaborative analysis of a delivery destination, in accordance with an embodiment of the disclosure. The order in which some or all of the process blocks appear in process 401 should not be deemed limiting. Rather, one of ordinary skill in the art having the benefit of the present disclosure will understand that some of the process blocks may be executed in a variety of orders not illustrated, or even in parallel.

In a process block 460, backend management system 325 receives query 330 from UAV 105. Query 330 includes an encoding of the initial aerial image 207 of the delivery destination. Based upon query 330, backend management system 325 can submit the image embedding to PNN 340 and/or LLM 345 (decision block 465). Several factors may be considered when deciding whether to use PNN 340 and/or LLM 345. For example, the LLM 345 may incur an additional fee and thus the delivery fee associated with the package may need to be sufficient to cover the expense. If the delivery is a delivery of first impression to the particular delivery destination, then it may be desirable to have LLM 345 analyze the scene. If the confidence level of onboard neural network 305 is particularly low, then it may be desirable to have LLM 345 analyze the scene. Backend management system 325 may have PNN 340 first analyze the scene and if its semantic analysis confidence level is low, then LLM 345 may be queried. In some embodiments, query 330 may reference the power budget of UAV 105 as it hovers over the delivery destination. If LLM 345 is a significantly higher latency search than PNN 340, the remaining power budget of UAV 105 may be a deciding factor depending upon the available power margins.

When backend management system 325 elects to query LLM 345, the prompt is generated (process block 470) and merged with image embedding, any context information, and a knowledge vector from knowledge database 350 (process block 475) to generate the query to LLM 345 (process block 480). In scenarios where PNN 340 is queried, process 401 continues to a process block 490. In process block 490, the image embedding from UAV 105 along with any context information and a knowledge vector from knowledge database 350 are merged into a vector query that is submitted as input to PNN 340 (process block 495). The output(s) from PNN 340 and/or LLM 345 are transmitted back to UAV 105 in response 245.

In some embodiments, backend management system 325 may compare the aerial image received from UAV 105 to NeRF model 355 to determine the precise location and pose of UAV 105 when capturing the initial aerial image 207. Alternatively, the context information embedded within query 330 may indicate the precise location and pose of UAV 105. From the location and pose information, backend management system 325 may use NeRF model 355 to generate a series of aerial images at different altitudes corresponding to a proposed descent path between initial higher altitude 120 and drop-off altitude 125. This series of NeRF generated aerial images may then be fed into one or both of PNN 340 or LLM 345 as seed images to generate a series of semantic segmentations at various different altitudes. This series of semantic segmentations may then be provided to UAV 105 with response 245 and represent segmented images that UAV 105 should expect to see as it descends to its drop-off altitude 125 over drop spot 115. Of course, the textual responses from LLM 345 may be converted to text embeddings prior to incorporation into response 245.

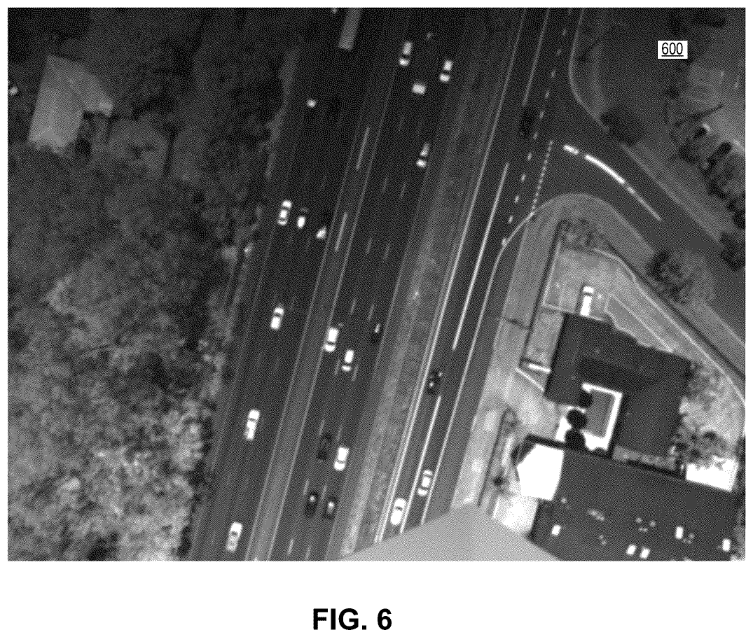

While the collaborative analysis/inference techniques described above are well suited to help UAVs 105 analyze and semantically segment difficult delivery destinations, collaborative inference may be used by UAVs 105 in other situations and/or other flight segments than just the delivery segment (e.g., during a cruise segment between terminal area 100 and the delivery destination). In particular, UAVs 105 may seek collaborative inference from cloud-based neural network 310, and specifically LLM 345, in emergency or other non-routine situations. For example, FIG. 6 is an example aerial image 600 from a UAV 105 during a cruise segment. If UAV 105 needs to make an unplanned or emergency landing, then UAV 105 could submit an encoding of aerial image 600 to cloud-based neural network 310 for analysis by LLM 345 along with a prompt such as, “I'm a delivery drone and I need to land. Where would it be safe to land given the image from my onboard camera?” An example response from LLM 345 may include “The safest place to land would be on the right side of the road, just past the house. There is a clear area there with no obstacles.” As discussed, this textual response may be communicated as a text embedding 361 in response 245 and input into onboard neural network 305 or used by other onboard algorithms/neural networks to aid identification of a safe landing location.

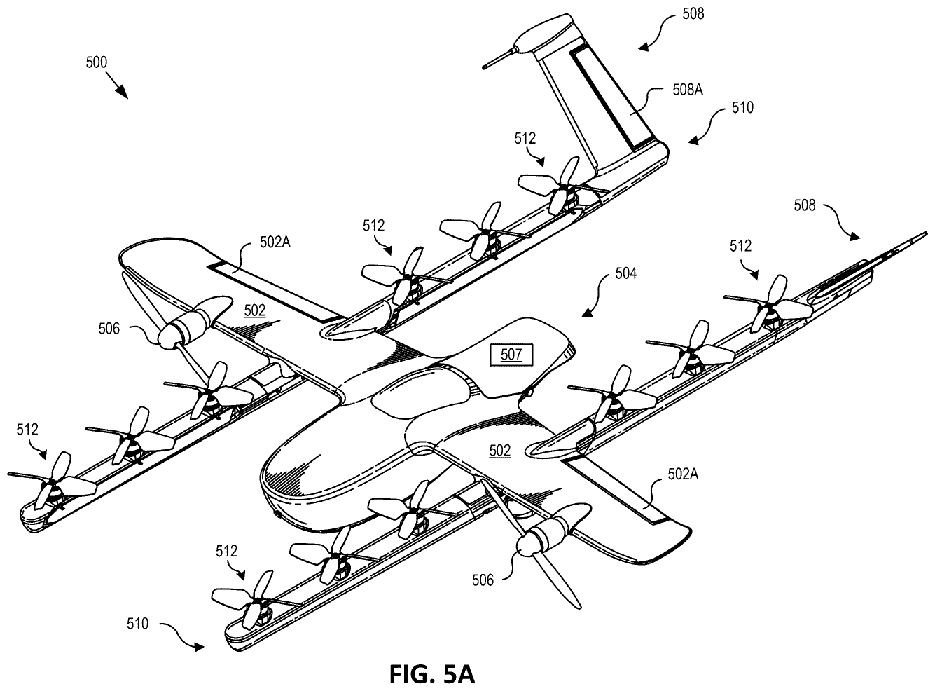

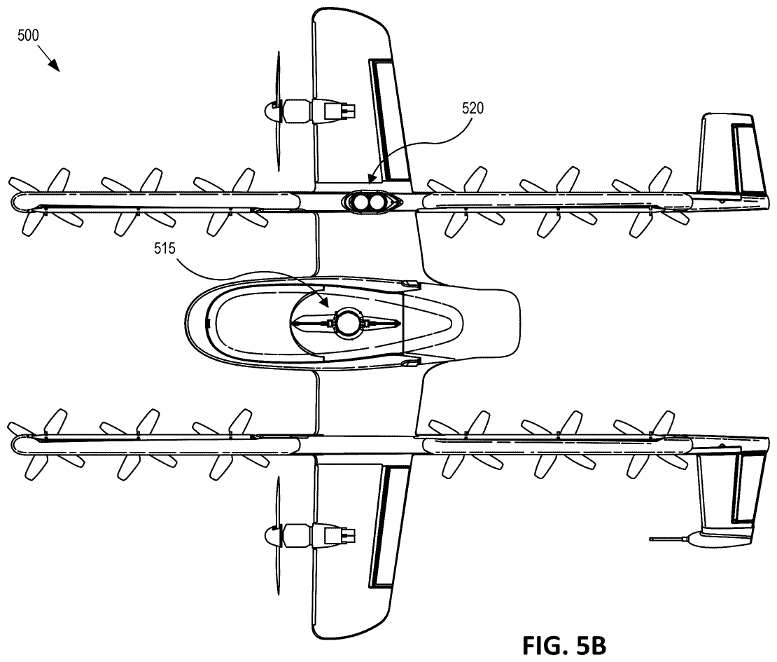

FIGS. 5A and 5B illustrate a UAV 500 that is well-suited for delivery of packages, in accordance with an embodiment of the disclosure. FIG. 5A is a topside perspective view illustration of UAV 500 while FIG. 5B is a bottom side plan view illustration of the same. UAV 500 is one possible implementation of UAVs 105 illustrated in FIG. 1, although other types of UAVs may be implemented for a UAV delivery service as well.

The illustrated embodiment of UAV 500 is a vertical takeoff and landing (VTOL) UAV that includes separate propulsion units 506 and 512 for providing horizontal and vertical propulsion, respectively. UAV 500 is a fixed-wing aerial vehicle, which as the name implies, has a wing assembly 502 that can generate lift based on the wing shape and the vehicle's forward airspeed when propelled horizontally by propulsion units 506. The illustrated embodiment of UAV 500 has an airframe that includes a fuselage 504 and wing assembly 502. In one embodiment, fuselage 504 is modular and includes a battery module, an avionics module, and a mission payload module. These modules are secured together to form the fuselage or main body.

The battery module (e.g., fore portion of fuselage 504) includes a cavity for housing one or more batteries for powering UAV 500. The avionics module (e.g., aft portion of fuselage 504) houses flight control circuitry of UAV 500, which may include a processor and memory, communication electronics and antennas (e.g., cellular transceiver, wifi transceiver, etc.), and various sensors (e.g., GNSS sensor, an inertial measurement unit, a magnetic compass, a radio frequency identifier reader, etc.). Collectively, these functional electronic subsystems for controlling UAV 500, communicating, and sensing the environment may be referred to as a control system 507. Control system 507 may incorporate many of the functional components of system 200 described in connection with FIG. 2. The mission payload module (e.g., middle portion of fuselage 504) houses equipment associated with a mission of UAV 500. For example, the mission payload module may include a payload actuator 515 (see FIG. 5B) for holding and releasing an externally attached payload (e.g., package for delivery). In some embodiments, the mission payload module may include camera/sensor equipment (e.g., camera, lenses, radar, lidar, pollution monitoring sensors, weather monitoring sensors, scanners, etc.). In FIG. 5B, an onboard camera 520 (e.g., onboard camera system 205) is mounted to the underside of UAV 500 to support a computer vision system (e.g., stereoscopic machine vision) for visual triangulation and navigation as well as operate as an optical code scanner for reading visual codes affixed to packages. These visual codes may be associated with or otherwise match to delivery missions and provide the UAV with a handle for accessing destination, delivery, and package validation information. Of course, onboard camera 520 may alternatively be integrated within fuselage 504.

As illustrated, UAV 500 includes horizontal propulsion units 506 positioned on wing assembly 502 for propelling UAV 500 horizontally. UAV 500 further includes two boom assemblies 510 that secure to wing assembly 502. Vertical propulsion units 512 are mounted to boom assemblies 510. Vertical propulsion units 512 providing vertical propulsion. Vertical propulsion units 512 may be used during a hover mode where UAV 500 is descending (e.g., to a delivery location), ascending (e.g., at initial launch or following a delivery), or maintaining a constant altitude. Stabilizers 508 (or tails) may be included with UAV 500 to control pitch and stabilize the aerial vehicle's yaw (left or right turns) during cruise. In some embodiments, during cruise mode vertical propulsion units 512 are disabled or powered low and during hover mode horizontal propulsion units 506 are disabled or powered low.

During flight, UAV 500 may control the direction and/or speed of its movement by controlling its pitch, roll, yaw, and/or altitude. Thrust from horizontal propulsion units 506 is used to control air speed. For example, the stabilizers 508 may include one or more rudders 508a for controlling the aerial vehicle's yaw, and wing assembly 502 may include elevators for controlling the aerial vehicle's pitch and/or ailerons 502a for controlling the aerial vehicle's roll. While the techniques described herein are particularly well-suited for VTOLs providing an aerial delivery service, it should be appreciated that the techniques described herein are generally applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 5A and 5B illustrate one wing assembly 502, two boom assemblies 510, two horizontal propulsion units 506, and six vertical propulsion units 512 per boom assembly 510, it should be appreciated that other variants of UAV 500 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of collaborative analysis of a delivery destination by an unmanned aerial vehicle (UAV) delivery service, the method comprising:
acquiring first and second aerial images of the delivery destination from a UAV of the UAV delivery service, wherein the first and second aerial images include depictions of objects at the delivery destination;
transmitting a query including an encoding of the first aerial image to a cloud-based neural network, wherein the cloud-based neural network is trained to identify one or more of the objects;
tracking a motion of the UAV between acquiring the first and second aerial images;
receiving a response from the cloud-based neural network identifying one or more of the objects depicted in the first aerial image; and
identifying, by an onboard neural network disposed on board the UAV, the objects at the delivery destination, wherein the onboard neural network receives as input the response, an indication of the motion tracked between the first and second aerial images, and the second aerial image when identifying the objects.

2. The method of claim 1, further comprising:
determining, by the UAV, whether or not to seek the collaborative analysis of the delivery destination prior to delivering a package to the delivery destination, wherein the determining is based at least in part on an identification confidence level for classifying one or more of the objects without aid from the cloud-based neural network.

3. The method of claim 2, wherein the determining is further based on at least one of a power budget of the UAV or a delivery fee for delivering the package.

4. The method of claim 1, wherein the query further includes context information describing one or more environmental factors present at the delivery destination when acquiring the first aerial image.

5. The method of claim 1, wherein the first aerial image is captured from a higher altitude above the delivery destination than the second aerial image, the method further comprising:
descending the UAV towards a delivery altitude while waiting for the response.

6. The method of claim 5, wherein the cloud-based neural network comprises a first semantic segmentation model that generates a baseline semantic segmentation of the first aerial image classifying the objects, the response includes the baseline semantic segmentation, and the onboard neural network comprises a second semantic segmentation model that generates a revised semantic segmentation based on the baseline semantic segmentation, the indication of the motion, and the second aerial image.

7. The method of claim 5, wherein the response includes a series of semantic segmentations from the cloud-based neural-network each representing a different semantic segmentation of the delivery destination at a different altitude.

8. The method of claim 5, further comprising:
maintaining a cloud-based neural radiance field (NeRF) model of the delivery destination;
querying the cloud-based NeRF model to generate a series of seed images to feed into the cloud-based neural network; and
generating the series of semantic segmentations with the cloud-based neural network based upon the series of seed images.

9. The method of claim 1, wherein the cloud-based neural network comprises a large language model (LLM) and the response includes a text embedding describing at least one obstacle to avoid or a drop spot for a package at the delivery destination.

10. The method of claim 9, further comprising:
providing the encoding of the first aerial image along with a textual prompt to the LLM.

11. The method of claim 1, further comprising:
maintaining a knowledge base of the delivery destination, the knowledge base including at least one of prior semantic segmentations or prior aerial images of the delivery destination, providing a knowledge vector of the knowledge base to the cloud-based neural network along with the query.

12. At least one machine-readable medium having instructions stored thereon that, in response to execution, cause an unmanned aerial vehicle (UAV) delivery service to perform operations comprising:
acquiring first and second aerial images of a ground area from a UAV of the UAV delivery service, wherein the first and second aerial images include depictions of objects at the ground area;
transmitting a query including an encoding of the first aerial image to a cloud-based neural network, wherein the cloud-based neural network is trained to identify one or more of the objects;
tracking a motion of the UAV between acquiring the first and second aerial images;
receiving a response from the cloud-based neural network identifying one or more of the objects depicted in the first aerial image; and
identifying, by an onboard neural network disposed on board the UAV, the objects at the ground area, wherein the onboard neural network receives as input the response, an indication of the motion tracked between the first and second aerial images, and the second aerial image when identifying the objects.

13. The at least one machine-readable medium of claim 12, wherein the ground area comprises a delivery destination, the operations further comprising:
determining, by the UAV, whether or not to seek a collaborative analysis of the delivery destination with the cloud-based neural network prior to delivering a package to the delivery destination, wherein the determining is based at least in part on an identification confidence level for classifying one or more of the objects without aid from the cloud-based neural network.

14. The at least one machine-readable medium of claim 13, wherein the determining is further based on at least one of a power budget of the UAV or a delivery fee for delivering the package.

15. The at least one machine-readable medium of claim 12, wherein the query further includes context information describing one or more environmental factors present at the ground area when acquiring the first aerial image.

16. The at least one machine-readable medium of claim 12, wherein the ground area comprises a delivery destination and wherein the first aerial image is captured from a higher altitude above the delivery destination than the second aerial image, the operations further comprising:
descending the UAV towards a delivery altitude while waiting for the response.

17. The at least one machine-readable medium of claim 16, wherein the cloud-based neural network comprises a first semantic segmentation model that generates a baseline semantic segmentation of the first aerial image classifying the objects, the response includes the baseline semantic segmentation, and the onboard neural network comprises a second semantic segmentation model that generates a revised semantic segmentation based on the baseline semantic segmentation, the indication of the motion, and the second aerial image.

18. The at least one machine-readable medium of claim 16, wherein the response includes a series of semantic segmentations from the cloud-based neural-network each representing a different semantic segmentation of the delivery destination at a different altitude.

19. The at least one machine-readable medium of claim 16, the operations further comprising:
maintaining a cloud-based neural radiance field (NeRF) model of the delivery destination;
querying the cloud-based NeRF model to generate a series of seed images to feed into the cloud-based neural network; and
generating the series of semantic segmentations with the cloud-based neural network based upon the series of seed images.

20. The at least one machine-readable medium of claim 12, wherein the cloud-based neural network comprises a large language model (LLM) and the response includes a text embedding describing one or more of the objects.

21. The at least one machine readable medium of claim 20, wherein the query is submitted to the cloud-based neural network in response to the UAV needing to identify an unplanned emergency landing location at the ground area.
